(19) United States
(12) Patent Application Publication
(10) Pub. No.: US 2018/0065351 A1
(43) Pub. Date: Mar. 8, 2018

(54) APPARATUS AND METHOD FOR MANUFACTURING VEHICLE DASH ISOLATION PAD

(71) Applicants: Hyundai Motor Company, Seoul (KR); Iksung Co., Ltd., Eumseong-gun (KR)

(72) Inventors: Bong-Kyung Son, Busan (KR); Kil-Bu Joo, Ulsan (KR); Min-Su Kim, Ulsan (KR); Bong-Jik Lee, Seongnam (KR); Ki-Wook Yang, Cheongju (KR)

(21) Appl. No.: 15/371,334

(22) Filed: Dec. 7, 2016

(30) Foreign Application Priority Data
Sep. 7, 2016 (KR) 10-2016-0114974

(51) Int. Cl. B32B 37/06; B32B 37/14; B32B 37/00; B60R 13/08

(52) U.S. Cl. CPC B32B 37/06; B32B 37/14; B32B 2605/00; B60R 13/0815; B32B 37/0053

(57) ABSTRACT

The present invention relates to an apparatus and a method for manufacturing a vehicle dash isolation pad. The method includes bonding a microfiber sound absorbing material to an adherend by using latent heat of a preheated adherend. As such, the vehicle dash isolation pad with improved weight reduction, sound absorption, and sound insulation effects can be obtained.

### CROSS-REFERENCE TO RELATED APPLICATIONS

This application claims priority under 35 U.S.C. §119 to Korean Patent Application No.10-2016-0114974, filed on Sep. 7, 2016, in the Korean Intellectual Property Office, the disclosure of which is incorporated herein by reference in its entirety.

### TECHNICAL FIELD

The present invention relates to an apparatus and a method for manufacturing an isolation pad, or a dash isolation pad for a vehicle, having reduced weight and improved sound absorption and sound insulation effects. The method may include bonding a microfiber sound absorbing material to an adherend by using latent heat of a preheated adherend.

### BACKGROUND OF THE INVENTION

In general, a sound absorbing material for a vehicle has been widely used for preventing noise generated when a vehicle is traveling from being introduced into the interior of the vehicle such that a passenger can feel the comfort. For instance, noise may be generated in an engine room to be transferred through air of a vehicle body, and by friction between wheels and the ground, and noise may be generated while a material such as small sand collides with the bottom of the vehicle during traveling, and the like may be included.

In order to suppress the noise, an engine cover, a hood insulator, or the like has been used, but actually, an effect of removing the noise has not been sufficient. Thus, a dash outer attached to the exterior of the vehicle, a dash inner attached to the interior, a floor carpet, and the like have been used to remove most of noise.

In recent years, in development trend of sound absorbing and insulating materials, researches to reduce a weight and improve performance through development of new materials with improved sound absorption and insulation and improvement of materials and structures of sound absorbing and insulating components have been continued. Among them, an isolation pad occupies most of weight of sound absorbing and insulating components and has a high sound absorbing and insulating contribution (about 80% during acceleration), and thus, development of low-weight and high-performance techniques has been demanded.

In the related arts, a dash isolation pad including polyethylene terephthalate (PET) and polyurethane (PU) has had problems such as heavy weight of about 3 to 4 Kg, dimension (thickness) instability, a yellowing phenomenon, deterioration of noise vibration performance (NVH performance) in aging, and the like, and thus improvement for this material has been required. For example, during a PU foaming process for manufacturing the material for the dash isolation pad, the process is complicated and producibility is deteriorated.

Accordingly, the present invention proposes an apparatus and a method for manufacturing a vehicle dash isolation pad which solve the above-indicated problems in the related art.

The foregoing is intended merely to aid in the understanding of the background of the present invention, and is not intended to mean that the present invention falls within the purview of the related art that is already known to those skilled in the art.

### SUMMARY OF THE INVENTION

In preferred aspects, the present invention provides an apparatus and a method for manufacturing an isolation pad for a vehicle with improved weight reduction, sound absorption, and sound insulation effects. Particularly, the method may include bonding a microfiber sound absorbing material and an adherend to each other by using latent heat of a preheated adherend.

The term “sound absorbing material” as used herein refers to a material that substantially absorb sound waves or sound energy such that sound transmission is substantially reduced from one side to the other side. Preferred sound absorbing material may reduce the sound or noise level to a level less than about 70%, less than about 60%, less than about 50%, less than about 40%, less than about 30%, less than about 20%, or less than about 10%, of the introduced sound level.

The term “adherend” as used herein refers to a material, substance or layer to which a microfiber sound absorbing material may be bonded by adhesive. The adherend is not particularly limited to a specific object, and the adherend may be the same material with or different material from the microfiber sound absorbing material. The adhesive suitably may be used as being positioned or disposed between the adherend to the microfiber sound absorbing material, and the bonding thereof may be performed by pressing, rolling, heating, preheating and the like.

The term “latent heat” as used herein refers to a thermal energy released from a body, e.g. adherend. Preferably, the latent heat may be released by the preheated adherent, which can transform from liquid to solid to after pretreatment (preheating process).

For instance, the method may provide a simplified process and improved workability by removing a PU foaming process.

Other technical objects desired to be achieved in the present invention are not limited to the aforementioned objects, and other technical objects not described above will be apparent to those skilled in the art from the disclosure of the present invention.

In one aspect, provided is an apparatus for manufacturing an isolation pad. The apparatus may comprise: a hot melt sprayer; a roller; a conveyer belt; a preheater; and a mold.

The term “hot melt sprayer” as used herein refers to a device or component that sprays a material that is melted, or substantially melted, for example, by heating the sprayed material or thermal spraying. Preferred hot melt sprayer may spray a resin or polymer by applying a heat or increasing internal temperature of the sprayer greater than a melting point of the resin or the polymer, such that the resin may be melted before at a nozzle of the hot melt sprayer. The hot melt sprayer may be connected or supplied with addition (external) heater unit or may be incorporated with a heater therein.

The hot melt sprayer may bond a resin to a non-woven fabric. In particular, the resin may be melt when the resin is bonded to the non-woven fabric.

The term “resin” as used herein refers to a resin comprising a polymer and preferably the resin comprises a polymer having a low melting point, for example, less than about 300° C., 250° C., 200° C., or 150° C., such that the resin may be readily melt as being applied and bonded on the non-woven fabric.

The roller may pass a microfiber sound absorbing material and the non-woven fabric to which the resin is bonded and an outer surface of the microfiber sound absorbing material may be covered with the non-woven fabric.

The preheater may preheat the adherend by applying heat.

The preheating temperature may be of about 150 to 300° C.

The mold may bond, mold, and trim the microfiber sound absorbing material and the adherend by latent heat of the preheated adherend.

In another aspect of the present invention, provided is a method for manufacturing an isolation pad. The method may include: preparing a microfiber sound absorbing material; bonding a resin to a non-woven fabric; contacting the microfiber sound absorbing material and the non-woven fabric to which the resin is bonded; preheating an adherend; inserting the preheated adherend and the microfiber sound absorbing material contacted with the non-woven fabric into a mold; and bonding the microfiber sound absorbing material and the adherend, molding, and trimming thereof.

Preferably, the microfiber sound absorbing material and the preheated adherend may be bonded to each other by latent heat of the preheated adherend.

The resin may be coated on the non-woven fabric by using a sprayer.

Preferably, an outer surface of the microfiber sound absorbing material may be covered by the non-woven fabric by passing the microfiber sound absorbing material and the resin through a roller.

An upper surface, a lower surface, or both surfaces of the upper surface and the lower surface of the microfiber sound absorbing material maybe covered by the non-woven fabric to which the low melting polymer resin is bonded.

The adherend may be preheated by using an oven.

The preheating temperature suitably may be of about 150 to 300° C.

Each of the adherend and the microfiber sound absorbing material may include at least one of polypropylene (PP), polyethylene terephthalate (PET), polyolefin (PO), polyamide (PA), and polyester (PE).

Further provided is an isolation pad manufactured by the method as described herein.

Moreover, the present invention provides a vehicle comprising the isolation pad manufactured by the method as described herein.

According to various exemplary embodiments of the present invention, the microfiber sound absorbing material and the adherend may be bonded to each other by using the latent heat, thereby reducing a weight and improving sound absorbing and insulating performance.

According to the present invention, simplified manufacturing process may be obtained and workability may be improved by removing a PU foaming process.

### BRIEF DESCRIPTION OF THE DRAWINGS

FIG. 1 is a photograph of an exemplary isolation pad or dah isolation pad for a vehicle according to an exemplary embodiment of the present invention.

FIG. 2 is a flowchart illustrating an exemplary method for manufacturing an exemplary dash isolation pad according to an exemplary embodiment of the present invention.

FIG. 3A is an enlarged photograph illustrating an exemplary microfiber sound absorbing material and a diameter of a microfiber web may be refined to form a fine diameter of about 0.3 to 10 μm.

FIG. 3B is an enlarged photograph illustrating various materials such as PP and PET may be used by diversifying staple fiber.

FIG. 3C is an enlarged photograph illustrating a fiber web formed through air blending to have a mixed form of the microfiber web and the staple fiber.

FIG. 4 illustrates an exemplary material for an exemplary dash isolation pad according to an exemplary embodiment of the present invention.

FIG. 5 illustrates an exemplary process of covering an outer surface of an exemplary microfiber sound absorbing material with an exemplary non-woven fabric by using a roller according to an exemplary embodiment of the present invention.

FIG. 6 illustrates an exemplary microfiber in which an exemplary low-melting polymer resin is bonded to one surface of an exemplary non-woven fabric according to an exemplary embodiment of the present invention.

FIG. 7 illustrates an exemplary microfiber in which an exemplary low-melting polymer resin is bonded to both surfaces of the non-woven fabric according to an exemplary embodiment of the present invention.

FIG. 8 is a photograph of an exemplary process of preheating an adherend according to an exemplary embodiment of the present invention.

FIG. 9A is a photograph of an exemplary process of inserting an exemplary microfiber sound absorbing material and an exemplary preheated adherend into a mold according to an exemplary embodiment of the present invention.

FIG. 9B is a photograph of bonding an exemplary microfiber sound absorbing material and an exemplary preheated adherend according to an exemplary embodiment of the present invention.

FIG. 9C is a photograph of molding and trimming an exemplary microfiber sound absorbing material and an exemplary preheated adherend according to an exemplary embodiment of the present invention.

FIG. 9D is a photograph of an exemplary isolation pad shaped according to an exemplary embodiment of the present invention.

FIG. 10A illustrates a cross-sectional view of an exemplary dash isolation pad for a vehicle according to an exemplary embodiment of the present invention.

FIG. 10B illustrates an exemplary adherend bonded to an exemplary microfiber 13 according to an exemplary embodiment of the present invention.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings. Terms or words used in the present specification and claims, which will be described below should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Therefore, configurations illustrated in the embodiments and the drawings described in the present specification are only the most preferred embodiment of the present invention and do not represent all of the technical spirit of the present invention, and thus it is to be understood that various modified examples, which may replace the configurations, are possible when filing the present application.

The present invention provides a method for manufacturing an isolation pad or dash isolation pad for a vehicle. In recent years, in development trend of sound absorbing and insulating materials, weights thereof have been reduced and performance has been improved through development of new materials with improved sound absorption and insulation and improvement of materials and structures of sound absorbing and insulating components. Particularly, a dash isolation pad is a component which occupies most of weight of sound absorbing and insulating components and has a high sound absorbing and insulating effects (for example, noise reduction of about 80% during acceleration), as such, development of low-weight and high-performance techniques has been demanded.

In the related art, a dash isolation pad including polyethylene terephthalate and polyurethane PU has problems including a heavy weight, for example, about 3 to 4 Kg, dimension (thickness) instability, a yellowing phenomenon, deterioration of noise vibration performance (NVH performance) in aging, and the like, and thus improvement for the problems is required.

As a result, techniques for an apparatus and a method for manufacturing an isolation pad, or a dash isolation pad for a vehicle with a reduced weight and improved sound absorbing and insulating performance have been required.

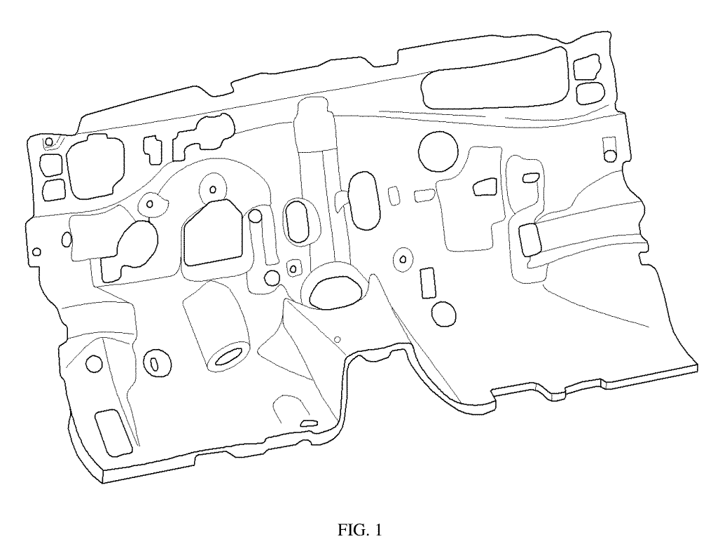

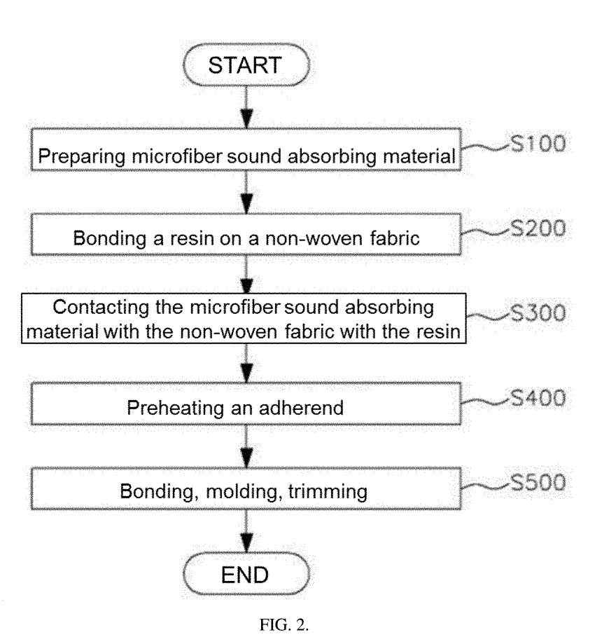

FIG. 1 is a photograph illustrating an exemplary dash isolation pad according to an exemplary embodiment of the present invention. In order to solve the aforementioned problems, optimization of a low-weight high-sound absorbing type dash isolation pad structure is required, and it is required to control a cross-sectional shape of PET yarn, a weight configuration of a sound insulating layer, a weight of a sound-absorbing layer, and a PET material ratio of the sound-absorbing layer. In other words, a sound-absorbing effect needs to be maximized by diversifying the cross-sectional shape of the PET yarn, a sound-insulating effect needs to be maximized by diversifying the PET weight of the sound-insulating layer having a triple-layer structure, a weight that is similar to a sound-absorbing characteristic effect for each weight of the sound-absorbing material and an application level of mass-produced vehicles needs to be selected, and a sound-absorbing effect through a mixed thread of PP and PET needs to be enhanced.

The method for manufacturing the isolation pad of the present invention may include preparing a microfiber sound absorbing material; bonding a resin to a non-woven fabric; contacting the microfiber sound absorbing material and the non-woven fabric to which the resin is bonded; preheating an adherend; inserting the preheated adherend and the microfiber sound absorbing material contacted with the non-woven fabric into a mold; and then bonding the adherend and the microfiber sound absorbing material, molding, and trimming thereof. Preparing microfiber sound absorbing material od for manufacturing a dash isolation pad according to an exemplary embodiment of the present invention. As described above, first, the microfiber sound absorbing material may be prepared (S100). Next, the non-woven fabric may be prepared and the resin may be bonded thereto (S200). Next, the microfiber sound absorbing material and the non-woven fabric to which the resin is bonded may contact each other (S300). Next, the adherend may be preheated (S400), and the preheated adherend and the microfiber sound absorbing material contacted with the non-woven fabric may be inserted into a mold and then bonded, molded, and trimmed (S500).

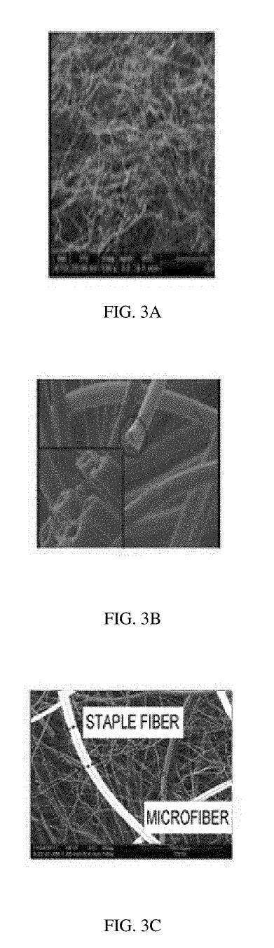

FIGS. 3A-3C show enlarged photographs illustrating an exemplary microfiber sound absorbing material. A diameter of a microfiber web may be refined to form a fine diameter of about 0.3 to 10 μm as shown in FIG. 3A. Meanwhile, various materials such as PP and PET may be used by diversifying staple fiber as shown in FIG. 3B. Further, a fiber web may be formed through air blending to have a mixed form of the microfiber web and the staple fiber as shown in FIG. 3C.

In the bonding, molding, and trimming (S500), a microfiber sound absorbing material 13 and an adherend 10 may be bonded to each other by latent heat of the preheated adherend 10.

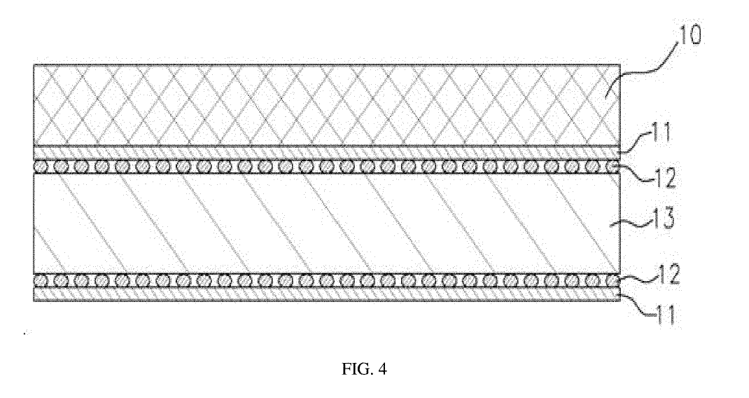

FIG. 4 is a cross-sectional view illustrating a material configuration of an exemplary dash isolation pad according to an exemplary embodiment of the present invention. The microfiber sound absorbing material 13 and a light non-woven fabric 11 may be bonded to each other through a resin 12 which is an adhesive and the adherend 10 may be bonded thereto.

In the bonding (S200), the resin 12 may be coated on the non-woven fabric 11 by using a sprayer. The sprayer may use a sprayer which is used in the related art, and for example, may use a hot melt sprayer.

In the contacting of the non-woven fabric (S300), an outer surface of the microfiber sound absorbing material 13 may be covered by the non-woven fabric 11 by passing the microfiber sound absorbing material 13 and the resin 12 through a roller.

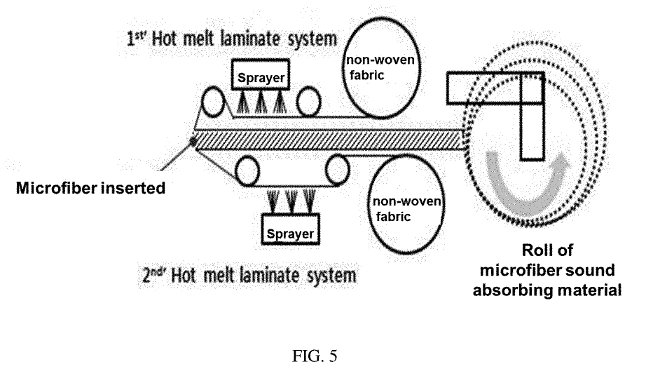

FIG. 5 is a cross-sectional view illustrating a step of covering an outer surface of the microfiber sound absorbing material with a non-woven fabric by using a roller according to the exemplary embodiment of the present invention. The outer surface of the microfiber sound absorbing material may be covered by the non-woven fabric by inserting a microfiber cloth and passing a non-woven fabric in which the resin may be bonded to the microfiber cloth through a roller.

An upper surface, a lower surface, or both surfaces of the upper surface and the lower surface of the microfiber sound absorbing material may be covered by the non-woven fabric to which the resin is bonded.

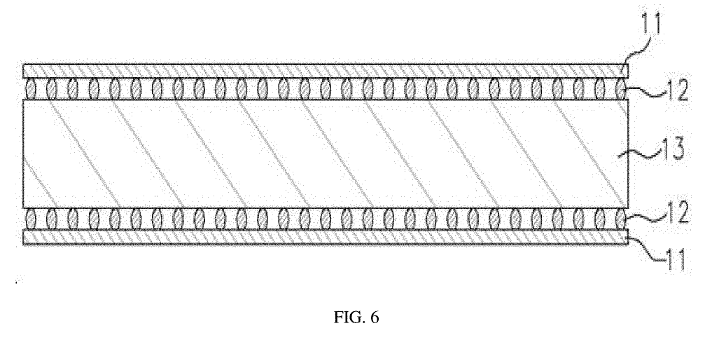

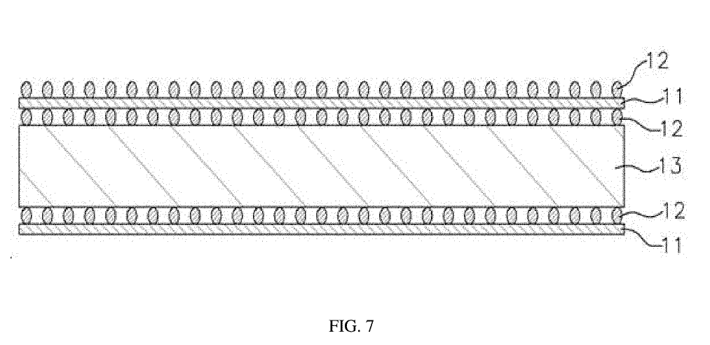

FIG. 6 is a cross-sectional view illustrating the microfiber 13 in which the resin 12 is bonded to one surface of the non-woven fabric 11 according to an exemplary embodiment of the present invention and FIG. 7 is a cross-sectional view illustrating the microfiber 13 in which the low melting polymer resin 12 is bonded to both surfaces of the non-woven fabric 11 according to an exemplary embodiment of the present invention. Alternately, the low melting polymer resin 1 may be bonded and used to one surface or both surfaces of the light non-woven fabric.

In the preheating of the adherend (S400), the adherend may be preheated by using an oven.

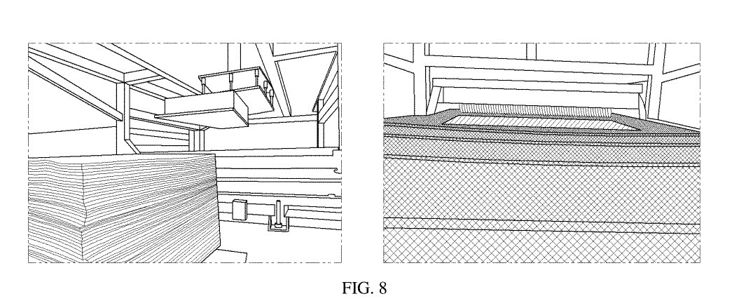

FIG. 8 is a photograph illustrating an exemplary process of preheating an adherend according to an exemplary embodiment of the present invention. The preheating of the adherend may use a known preheater or oven and also use a conveyer belt if necessary.

A preheating temperature of the adherend may be of about 150 to 300° C.

Each the adherend and the microfiber sound absorbing material may include at least one of polypropylene (PP), polyethylene terephthalate (PET), polyolefin (PO), polyamide (PA), and polyester (PE).

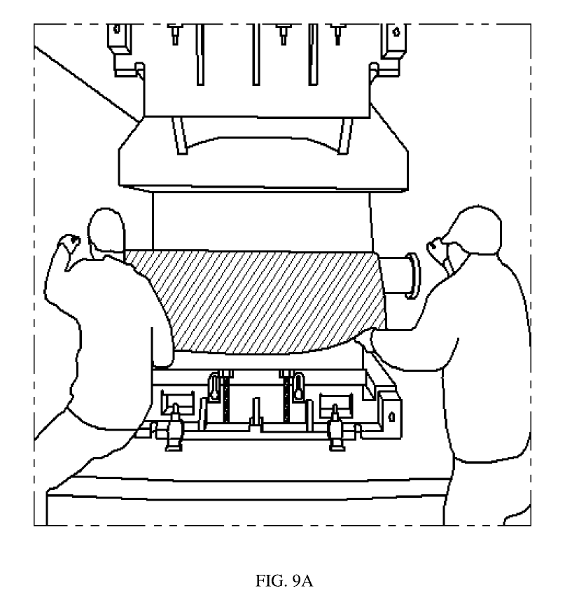

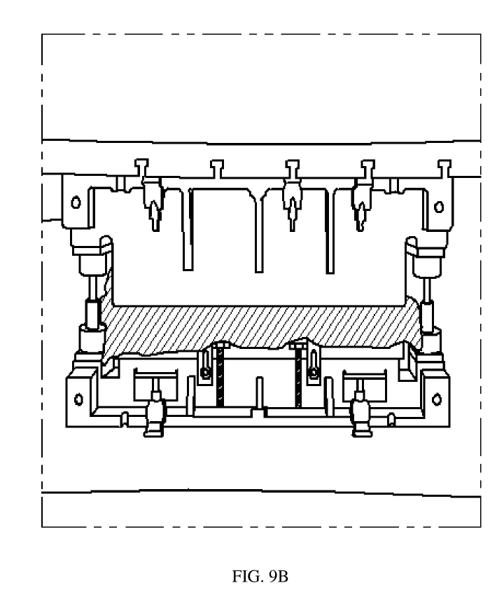

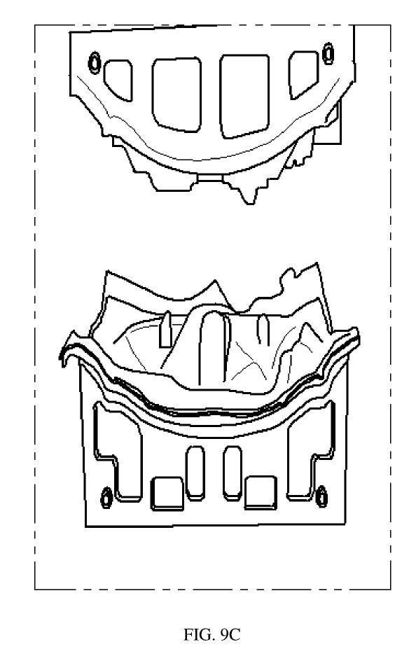

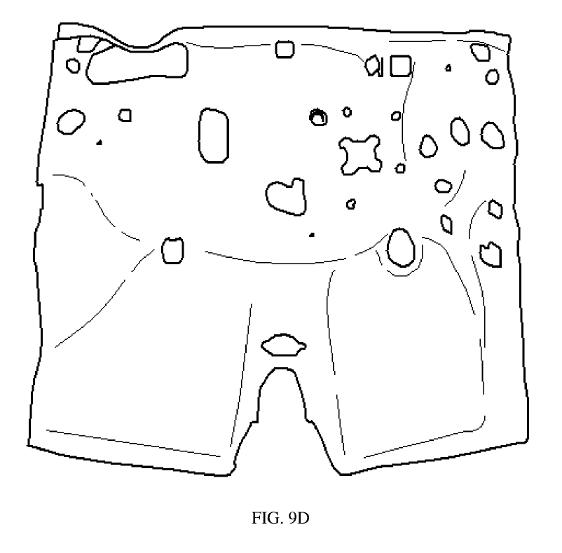

FIG. 9A-9D show a photograph illustrating a step of inserting and then bonding, molding, and trimming (S500) a microfiber sound absorbing material in which the preheated adherend and the non-woven fabric contact each other into a mold according to an exemplary embodiment of the present invention. As illustrated in FIG. 9A, the preheated adherend and the microfiber sound absorbing material may be inserted to the mold and then bonded, molded, and trimmed as illustrated in FIGS. 9B and 9C to manufacture one component having a shape illustrated in FIG. 9D.

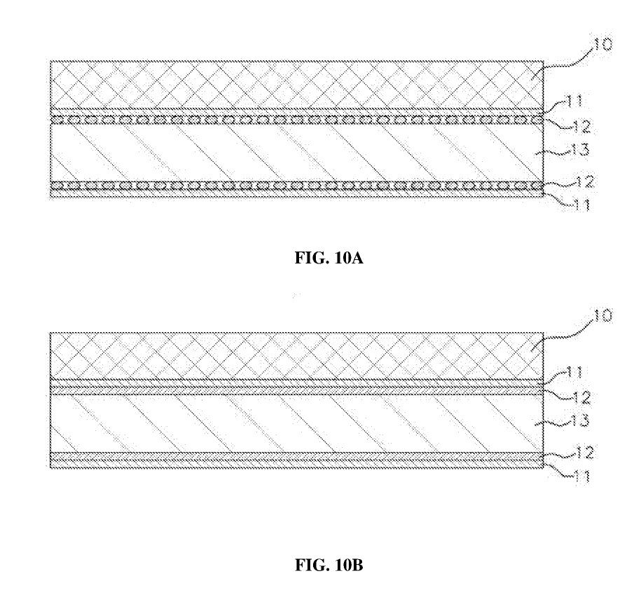

Meanwhile, FIG. 10A-10B show cross-sectional views illustrating an exemplary dash isolation pad according to an exemplary embodiment of the present invention. The light non-woven fabric 11, the resin 12 as the adhesive, the microfiber sound absorbing material 13, the resin 12, and the light non-woven fabric 11 may be positioned below the adherend 10 and inserted to the mold and then bonded, molded, and trimmed. While the bonded low melting polymer resin 12 is dissolved by latent heat of the preheated adherend 10, the adherend 10 and the microfiber 13 may be bonded to each other as shown in FIG. 10B.

An apparatus for manufacturing a vehicle dash isolation pad of the present invention may include a hot melt sprayer; a roller; a conveyer belt; a preheater; and a bonding, molding, and trimming mold.

The hot melt sprayer may bond the resin 12, for example, a having a low melting point, to the non-woven fabric 11, and the roller may pass the microfiber sound absorbing material 13 and the non-woven fabric to which the resin is bonded such that the outer surface of the microfiber sound absorbing material may be covered with the non-woven fabric.

The preheater may preheat the adherend by applying heat and the preheating temperature may be of about 150 to 300° C.

The bonding, molding, and trimming mold may bond, mold, and trim the microfiber sound absorbing material and the adherend by latent heat of the preheated adherend 10.

As such, according to various exemplary embodiments of the present invention, the microfiber sound absorbing material and the adherend may be bonded to each other by using the latent heat, thereby reducing a weight and improving sound absorbing and insulating performance.

Further, as consequence, a process for manufacturing an isolation pad for a vehicle may be simplified and workability may be substantially improved by removing a PU foaming process.

Although exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for manufacturing a vehicle dash isolation pad, comprising:
a hot melt sprayer spraying a hot melt resin to a non-woven fabric;
a roller bonding a microfiber sound absorbing material to the non-woven fabric sprayed with the a hot melt resin;
a preheater preheating an adherend;
a mold molding, trimming and bonding the adherend and the non-woven fabric adhered with the microfiber sound absorbing material.

2. The apparatus of claim 1, wherein the hot melt sprayer bonds a resin to a non-woven fabric, wherein the resin is melt when the resin is bonded to the non-woven fabric.

3. The apparatus of claim 2, wherein the roller passes a microfiber sound absorbing material and the non-woven fabric to which the low melting polymer resin is bonded and an outer surface of the microfiber sound absorbing material is covered with the non-woven fabric.

4. The apparatus of claim 1, wherein the preheater preheats an adherend by applying heat.

5. The apparatus of claim 4, wherein the preheating temperature is from about 150 to about 300° C.

6. The apparatus of claim 4, wherein the mold bonds, molds, and trims the microfiber sound absorbing material and the adherend by latent heat of the preheated adherend.

7. A method for manufacturing an isolation pad, comprising:
preparing a microfiber sound absorbing material;
bonding a resin to a non-woven fabric;
contacting the microfiber sound absorbing material and the non-woven fabric to which the low melting polymer resin is bonded;
preheating an adherend;
inserting the preheated adherend and the microfiber sound absorbing material contacted with the non-woven fabric into a mold;
bonding, molding, and trimming the microfiber sound absorbing material and the adherend.

8. The method of claim 7, wherein the microfiber sound absorbing material and the preheated adherend are bonded to each other by latent heat of the preheated adherend.

9. The method of claim 7, wherein the resin is coated on the non-woven fabric by using a sprayer.

10. The method of claim 7, wherein an outer surface of the microfiber sound absorbing material is covered by the non-woven fabric by passing the microfiber sound absorbing material and the resin through a roller.

11. The method of claim 10, wherein an upper surface, a lower surface, or both surfaces of the upper surface and the lower surface of the microfiber sound absorbing material is covered by the non-woven fabric to which the resin is bonded.

12. The method of claim 7, wherein in the preheating of the adherend, the adherend is preheated by using an oven.

13. The method of claim 7, wherein the preheating temperature is from about 150 to about 300° C.

14. The method of claim 7, wherein each of the adherend and the microfiber sound absorbing material comprises at least one of polypropylene (PP), polyethylene terephthalate (PET), polyolefin (PO), polyamide (PA), and polyester (PE).

15. An isolation pad manufactured by a method of claim 7.

16. A vehicle comprising the isolation pad of claim 15.
